(19) United States
(12) Patent Application Publication
(10) Pub. No.: US 2024/0191102 A1
(43) Pub. Date: Jun. 13, 2024

(54) UV RELEASE TAPE

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Chen-Ho Lai, TAIPEI (TW)

(21) Appl. No.: 18/169,847

(22) Filed: Feb. 15, 2023

(30) Foreign Application Priority Data
Dec. 7, 2022 (TW) 111146881

(51) Int. Cl. C09J 7/20; C09J 7/24; C09J 133/08

(52) U.S. Cl. CPC C09J 7/203; C09J 7/245; C09J 133/08; C09J 2301/312; C09J 2301/416

(57) ABSTRACT

A UV release tape includes a substrate layer, a UV release layer, and a separation layer. The UV release layer is disposed between the substrate layer and the separation layer. A material of the substrate layer includes a polyvinyl chloride, a plasticizer, and a metal salt compound. Relative to 100 phr of the polyvinyl chloride, an amount of the metal salt compound ranges from 1 phr to 8 phr. The metal salt compound includes a calcium salt compound and a zinc salt compound. A peeling strength of the UV release layer toward a silicon wafer is higher than 10 N/in. After being exposed to UV light, the peeling strength of the UV release layer toward the silicon wafer is lower than 0.3 N/in.

### CROSS-REFERENCE TO RELATED PATENT APPLICATION

This application claims the benefit of priority to Taiwan Patent Application No. 111146881, filed on Dec. 7, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a UV release tape, and more particularly to a UV release tape applied to the semiconductor manufacturing process (wafer back grinding and wafer dicing).

### BACKGROUND OF THE DISCLOSURE

In the semiconductor manufacturing process, adhesive tape is often used to fix the wafer, especially in the steps of wafer back grinding and wafer dicing.

The thickness of the wafer can be reduced through the step of wafer back grinding, thereby obtaining a thinner wafer. In order to protect the surface of the wafer, the adhesive tape is completely attached to the surface of the wafer when the wafer back is ground, so as to prevent the surface of the wafer from being worn or polluted by the grinding liquid.

In the step of wafer dicing, the adhesive tape is used to fix the wafer, so as to facilitate precise cutting of the wafer to obtain small-sized dies. The use of adhesive tape can prevent wafer displacement or flying bits during wafer dicing.

Common adhesive tapes on the market can be divided into non-UV adhesive tapes and UV adhesive tapes. Generally speaking, the adhesive force of non-UV type adhesive tape is lower than that of UV type adhesive tape. Therefore, after use, the non-UV adhesive tape can be directly separated from the wafer, while the UV adhesive tape can be separated from the wafer after being exposed to a UV light.

In order to have both the effect of fixing the wafer and being able to separate from the wafer, the adhesive tape needs to have a specific adhesive force, and it is necessary to avoid the problems of the adhesive force fading over time, softening of the UV release layer, or adhesive residue. Therefore, how to improve the characteristics of the adhesive tape through the design of the material and structure, so as to promote its convenience in use, has become one of the important issues to be addressed in the relevant industry.

### SUMMARY OF THE DISCLOSURE

In response to the above-referenced technical inadequacies, the present disclosure provides a UV release tape.

In order to solve the above technical problems, one of the technical solutions adopted by the present disclosure provides a UV release tape. The UV release tape includes a substrate layer, a UV release layer, and a separation layer. The UV release layer is disposed between the substrate layer and the separation layer. A material of the substrate layer includes a polyvinyl chloride, a plasticizer and a metal salt compound. An amount of the metal salt compound ranges from 1 phr to 8 phr based on the polyvinyl chloride having a total weight of 100 phr. The metal salt compound includes a calcium salt compound and a zinc salt compound. A peeling strength of the UV release layer toward a silicon wafer is greater than 10 N/in, and after being exposed to ultraviolet light, the peeling strength of the UV release layer toward the silicon wafer is less than 0.3 N/in.

In certain embodiments, an addition ratio of the calcium salt compound and the zinc salt compound is between 1:1 and 10.

In certain embodiments, the plasticizer is added in an amount of 20 phr to 65 phr based on the polyvinyl chloride having a total weight of 100 phr.

In certain embodiments, one surface of the substrate layer has an isolation layer, and the isolation layer is in contact with the UV release layer.

In certain embodiments, a material of the isolation layer includes an ethyl acetate-maleic anhydride-vinyl chloride copolymer, a copolymer of methyl methacrylate and a natural rubber, or a mixture of a polyvinyl chloride and a vinyl chloride resin.

In certain embodiments, a material of the isolation layer includes 75 phr to 95 phr of a polyvinyl chloride and 5 phr to 25 phr of a vinyl acetate resin.

In certain embodiments, the vinyl chloride resin includes a vinyl chloride-vinyl acetate binary copolymer, a vinyl chloride-vinyl acetate-vinyl alcohol terpolymer, a vinyl chloride-vinyl acetate-maleic anhydride terpolymer, a vinyl chloride-vinyl acetate-hydroxyethyl acrylate terpolymer, or a combination thereof.

In certain embodiments, the UV release layer is formed by an adhesive composition, and the adhesive composition includes: 20 phr to 60 phr of an acryl polymer, 2 phr to 20 phr of an acrylic polymer, 0.2 phr to 2 phr of a hardener, and 0.5 phr to 5 phr of a photoinitiator.

In certain embodiments, an ultraviolet light transmittance of the UV release tape is greater than 70%.

In certain embodiments, a thickness of the substrate layer ranges from 60 microns to 90 microns.

One of the beneficial effects of the present disclosure is that, by virtue of “a material of the substrate layer including polyvinyl chloride, a plasticizer, and a metal salt compound”, and “the metal salt compound including a calcium salt compound and a zinc salt compound” the UV release tape can maintain a proper peeling strength and an optimal peeling strength after a long-term use, and does not leave an adhesive residue.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic side view of a UV release tape of Example 1 of the present disclosure;

FIG. 2 is a schematic side view of the UV release tape of Example 2 of the present disclosure;

FIG. 3 is a schematic view of the UV release tape of Example 2 during use according to the present disclosure; and

FIG. 4 is a schematic view of the UV release tape of Example 2 after use according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

A UV release tape of the present disclosure is a UV type release tape, has a proper peeling strength, and is applicable to the semiconductor manufacturing process, especially to the steps of wafer back grinding and wafer dicing. During use, the UV release tape can be well attached to the silicon wafer to achieve the effect of protecting the silicon wafer or fixing the silicon wafer. After use, the adhesive force of the UV release tape on the silicon wafer can be reduced by irradiation of an ultraviolet light, and the UV release tape can be easily peeled off from the silicon wafer without having any adhesive residue. Silicon wafers are used as examples in the description, but in actual use, the UV release tape of the present disclosure is not limited to being used on silicon wafers, and can also be used on electronic components or other substrates.

Specifically, a peeling strength (P₀) of the UV release tape on the silicon wafer is greater than 10 N/in before being exposed to ultraviolet light. After being exposed to the ultraviolet light, a peeling strength (P₁) of the UV release tape on the silicon wafer is less than 0.3 N/in. For the convenience of definition, a ratio ((P₀−P₁)/P₀) of the peeling strength difference (P₀−P₁) before and after ultraviolet light irradiation to the peeling strength (P₀) before ultraviolet light irradiation is defined as a change rate of the peeling strength. When the UV release tape has a high change rate of the peeling strength, this signifies that the peeling strength of the UV release tape will be greatly reduced after being exposed to the ultraviolet light, such that the UV release tape can be easily and conveniently peeled off from the silicon wafer.

In the present disclosure, the change rate of the peeling strength of the UV release tape is greater than 65%. Preferably, the change rate of the peeling strength of the UV release tape can be greater than 70%, 75%, 80%, 85%, 90%, 95%, 96%, 97%, 98% or 99%.

### Example 1

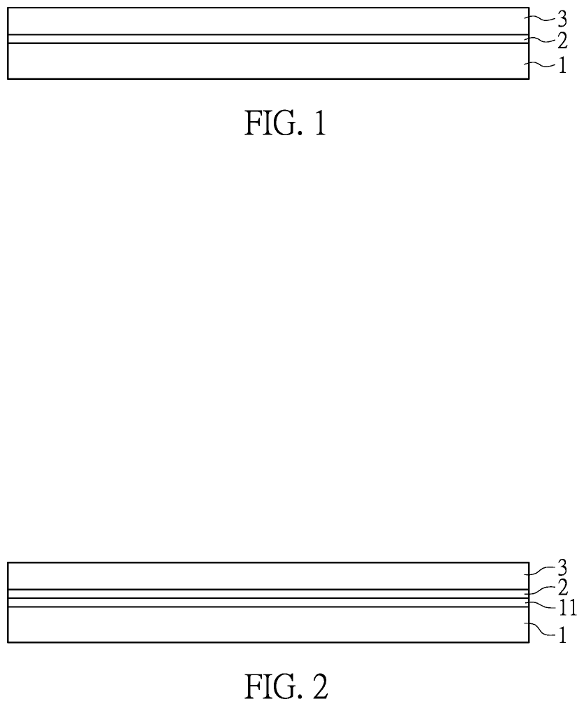

Reference is made to FIG. 1. Example 1 of the present disclosure provides a UV release tape, which includes: a substrate layer 1, a UV release layer 2 and a separation layer 3.

A material of the substrate layer 1 includes a polyvinyl chloride, a plasticizer, and a metal salt compound. Polyvinyl chloride has excellent impact resistance, ductility and weather resistance, which can make the substrate layer 1 have a bendable property and protect the silicon wafer. The addition of plasticizer can improve the processability of polyvinyl chloride, and enhance the convenience of the process involving the UV release tape. The addition of metal salt compound can help stabilize the polyvinyl chloride to prevent the polyvinyl chloride from decomposing to produce hydrogen chloride under a high temperature condition of 120° ° C. to 130° C., and the hydrogen chloride will accelerate the decomposition of polyvinyl chloride. In addition, when a thermal history of polyvinyl chloride lasts for too long, polyvinyl chloride tends to yellow.

In certain embodiments, a material of the substrate layer 1 includes 100 phr of a polyvinyl chloride, 20 phr to 65 phr of a plasticizer and 1 phr to 8 phr of a metal salt compound. For example, an addition amount of the plasticizer can be 25 phr, 30 phr, 35 phr, 40 phr, 45 phr, 50 phr, 55 phr or 60 phr. An addition amount of the metal salt compound can be 2 phr, 3 phr, 4 phr, 5 phr, 6 phr or 7 phr.

For example, the plasticizer can be dioctyl terephthalate (DOTP), di-iso-nonyl phthalate (DINP), di-(2-propylheptyl) phthalate (DPHP), 1,2-cyclohexanedicarboxylate isononyl ester (DHIN), diethylhexyl phthalate (DEHP) or epoxidized soybean oil. However, the present disclosure is not limited thereto.

In an exemplary embodiment, the metal salt compound includes a calcium salt compound and a zinc salt compound, and a ratio of the calcium salt compound to the zinc salt compound is 1:1 to 10, such as 1:2, 1:3, 1:4, 1:5, 1:6, 1:7, 1:8 or 1:9.

When the material of the substrate layer includes both the calcium salt compound and the zinc salt compound, the polyvinyl chloride can be prevented from decomposing under a high temperature condition (120° C. to 130° C.), thereby avoiding yellowing.

In an exemplary embodiment, the metal salt compound includes a calcium salt compound and a zinc salt compound, and a ratio of the calcium salt compound to the zinc salt compound is 1:1 to 10, such as 1:2, 1:3, 1:4, 1:5, 1:6, 1:7, 1:8 or 1:9. When the material of the substrate layer includes both the calcium salt compound and the zinc salt compound, the polyvinyl chloride can be prevented from decomposing under a high temperature condition (120° C. to) 130° ° C., thereby avoiding yellowing. In an exemplary embodiment, the calcium salt compound is calcium stearate, and the zinc salt compound is zinc stearate.

It is worth noting that in order to make the UV release tape have a high change rate of peeling strength, the UV release tape needs to have a good UV light transmittance, so that the UV release layer 2 can be exposed to ultraviolet light.

When the calcium salt compound and the zinc salt compound are selected as the metal salt compound, the substrate layer 1 can maintain a good ultraviolet light transmittance (greater than 70%). In this way, when the ultraviolet light is used to irradiate the UV release tape, it can be ensured that the ultraviolet light penetrates the substrate layer 1 and irradiates the UV release layer 2. Therefore, after the UV release layer 2 undergoes peptization, it can be completely peeled off from the silicon wafer without having residual adhesive.

The material of the substrate layer 1 may further include a modifier, a lubricant and a colorant. An addition amount of the modifier is 1 phr to 4 phr, an addition amount of the lubricant is 0.1 phr to 1 phr, and an addition amount of the colorant is 0.1 phr to 4 phr based on the polyvinyl chloride having a total weight of 100 phr.

For example, the addition of the modifiers can speed up the plasticizing process of polyvinyl chloride, thereby improving the rheological properties of thermoplastic melts, promoting the mechanical properties of melts in thermoplastic state and the appearance quality and mechanical strength of the finished product. The modifier can be chlorinated polyethylene, methyl methacrylate-butadiene-styrene copolymer, acrylonitrile-butadiene-styrene copolymer, ethylene-vinyl acetate copolymer (EVA), acrylate copolymer (ACR), and acrylonitrile or butadiene random copolymer.

The lubricant can maintain the smoothness of the surface of the UV release tape, and the lubricant can be phthalates, citrates, acetyl citrates, ethylene-vinyl acetate copolymer waxes, paraffin waxes, polyethylene waxes, polypropylene waxes, oxidized polyethylene waxes, amide waxes (oleamide, mustard amide), ester wax (monoglyceride, pentaerythritol ester, n-butyl stearate), stearic acid, stearate, metabenzoate, white mineral oil or silicone. However, the present disclosure is not limited thereto.

The UV release layer 2 is disposed between the substrate layer 1 and the separation layer 3. Moreover, an adhesive force of the UV release layer 2 toward the substrate layer 1 is greater than an adhesive force of the UV release layer 2 toward the separation layer 3.

The UV release layer 2 is formed by an adhesive composition, and the adhesive composition includes: 20 phr to 60 phr of an acryl polymer, 2 phr to 20 phr of an acrylic polymer, 0.2 phr to 2 phr of a hardener, 0.5 phr to 5 phr of a photoinitiator, and 20 phr to 80 phr of a solvent. In brief, the UV release layer 2 can be an acrylic UV release layer. However, the present disclosure is not limited thereto.

Specifically, the acryl polymer can be polymethylmethacrylate, polyn-butylacrylate, polyisobutylacrylate, polyisooctylacrylate, polyhydroxyethylacrylate, polymethacrylic acid, polyhydroxyethylmethacrylate polymers or derivatives thereof. The acryl monomer may be methyl methacrylate, n-butyl acrylate, isobutyl acrylate, isooctyl acrylate, hydroxyethyl acrylate, methacrylic acid, hydroxyethyl methacrylate or derivatives thereof. The hardener can be organic peroxide mixture, diaminodiphenylmethane, m-phenylenediamine, diaminodiphenylene, diethyltoluenediamine or diaminodiphenylmethane. The photoinitiator can be azoisobutyronitrile, dibenzoyl peroxide, peroxide series or azo compound series. The solvent can be acetone, IPA, methanol or ethyl acetate. However, the present disclosure is not limited thereto.

The separation layer 3 is disposed on the UV release layer 2 and can be separated from the UV release layer 2. Before using the UV release tape, the separation layer 3 is torn off, and then the UV release layer 2 is adhered onto a silicon wafer.

In an exemplary embodiment, a thickness of the UV release tape ranges from 85 microns to 220 microns. Specifically, a thickness of the substrate layer 1 may range from 60 microns to 150 microns, for example: 70 microns, 80 microns, 90 microns, 100 microns, 110 microns, 120 microns, 130 microns or 140 microns. A thickness of the UV release layer 2 may range from 8 microns to 20 microns, for example: 10 microns, 12.5 microns, 15 microns or 17.5 microns. A thickness of the separation layer 3 may range from 20 microns to 50 microns, for example: 25 microns, 30 microns, 35 microns, 40 microns or 45 microns.

Regarding a manufacturing process of the UV release tape, the materials forming the substrate layer 1 are mixed evenly with a high-speed mixer, and then a PVC layer can be made by calendering, blow molding, casting or T-die extrusion. Next, an adhesive composition is coated on the separation layer 3 (a PET release film), and the polyvinyl chloride layer is placed on the adhesive composition. After drying and curing, the UV release tape of the present disclosure can be obtained.

### Example 2

Reference is made to FIG. 2. Example 2 of the present disclosure provides a UV release tape, which includes: a substrate layer 1, a UV release layer 2 and a separation layer 3 similar to those of Example 1.

Under a condition of high temperature and high pressure or presence of a solvent, the plasticizer in the substrate layer 1 will move from the interior of the substrate layer 1 to the UV release layer 2, so that the UV release layer 2 is softened, resulting in the problem of strength degradation. In addition, the plasticizer moving to the UV release layer 2 may affect the effect of ultraviolet light absorption of the UV release layer 2. Once the UV release layer 2 is not completely degummed, adhesive residue may be formed on the silicon wafer.

Therefore, in order to avoid moving of the plasticizer, the present disclosure provides an isolation layer 11 on one surface of the substrate layer 1, and makes the isolation layer 11 come in contact with the UV release layer 2 to block the movement of the plasticizer. That is to say, the disposition of the isolation layer 11 can prevent the adhesive strength degradation of the UV release layer 2 and the problems relating to adhesive residue after the UV release tape is peeled off from the silicon wafer. In certain embodiments, the thickness of the substrate layer 1 and the isolation layer 11 may range from 60 microns to 150 microns.

In certain embodiments, the isolation layer 11 and the substrate layer 1 are integrally formed. For example, the isolation layer 11 and the substrate layer 1 can be integrally formed by co-extrusion or other lamination methods. In other embodiments, the isolation layer 11 can be formed on the substrate layer 1 by coating.

The material of the isolation layer 11 can be a copolymer of ethyl acetate-maleic anhydride-vinyl chloride copolymer, a copolymer of methyl methacrylate and natural rubber, or a mixture of vinyl chloride-vinyl acetate based copolymer (hereinafter referred to as vinyl acetate resin). Moreover, the materials can form the isolation layer by means of co-extrusion or coating. However, the present disclosure is not limited thereto.

When the material of the isolation layer 11 is a mixture of polyvinyl chloride and vinyl chloride resin, the material of the isolation layer 11 may include 75 phr to 95 phr of polyvinyl chloride and 5 phr to 25 phr of vinyl chloride resin. Specifically, the vinyl chloride resin includes a vinyl chloride-vinyl acetate binary copolymer, a vinyl chloride-vinyl acetate-vinyl alcohol terpolymer, a vinyl chloride-vinyl acetate-maleic anhydride terpolymer, a vinyl chloride-vinyl acetate-hydroxyethyl acrylate terpolymer, or a combination thereof. However, the present disclosure is not limited thereto.

The material of the isolation layer 11 may further include an antistatic agent, and an addition of the antistatic agent can prevent silicon wafers or electronic components from being damaged by static electricity. The antistatic agent may be a cationic antistatic agent, an anionic antistatic agent, a zwitterionic antistatic agent or a nonionic antistatic agent. The cationic antistatic agent can be ammonium salt, quaternary ammonium salt, alkyl imidazoline or alkyl imidazoline salt. The anionic antistatic agent can be sodium alkyl sulfonate, phosphate ester or phosphate salt. The zwitterionic antistatic agent may be an alkyl dihydroxyethyl ammonium betaine salt or an N-alkyl amino acid salt. Nonionic antistatic agent can be fatty acid-ethylene oxide adducts, fatty alcohol-ethylene oxide adducts or alkylphenol-ethylene oxide adducts.

In some embodiments, the material of the substrate layer 1 may also include polyolefin. The use of polyolefin can replace a part of polyvinyl chloride to reduce an amount of the plasticizer that is used. In other words, the substrate layer 1 may be composed of a polyvinyl chloride layer and a polyolefin layer, and the way of lamination is not limited. The material of the polyvinyl chloride layer is the same as that of the substrate layer 1 in Example 1, so it will not be repeated here. The material of polyolefin layer can include 5 phr to 95 phr of the polyethylene, 5 phr to 95 phr of the polypropylene, 0.1 phr to 1 phr of the lubricant, 0.1 phr to 4 phr of the colorant and 0.5 phr to 6.5 phr of an antioxidant.

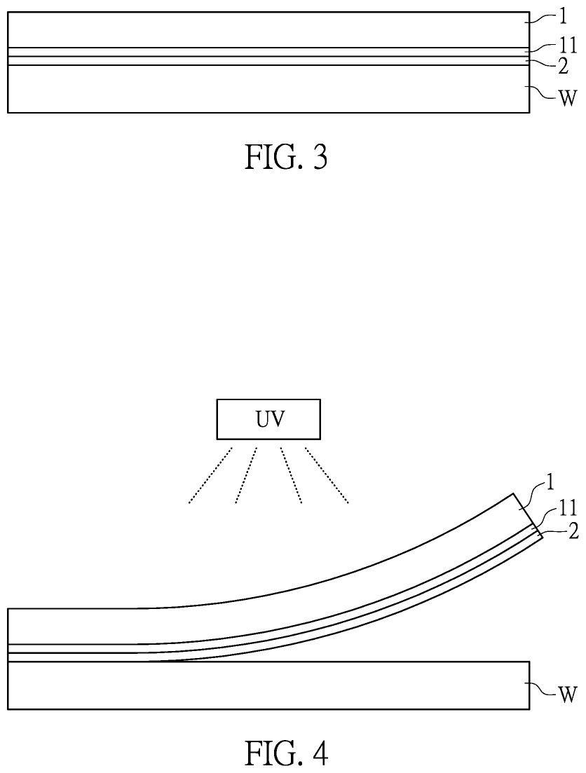

Reference is made to FIG. 3 and FIG. 4. FIG. 3 and FIG. 4 are schematic diagrams of the use of the UV release tape of the present disclosure. When the UV release tape is used, the separation layer 3 is torn off, and then the UV release layer 2 is adhered onto the silicon wafer W (as shown in FIG. 3) to achieve the effect of protection or fixing. After use, the UV release tape is exposed to ultraviolet light to degum the UV release layer 2, and then the substrate layer 1 and the UV release layer 2 are separated from the silicon wafer W.

In order to confirm that the UV release tape of the present disclosure has a proper peeling strength, the difference between the UV release tapes manufactured by the structure of Examples 1-3 and that manufactured by the structure of Comparative Examples 1-3 is that the metal salt compound in the Examples 1-3 includes a calcium salt compound and a zinc salt compound, and the metal salt compound in the Comparative Examples 1-3 includes a barium salt compound and a zinc salt compound.

A formula of the substrate layer material in the UV release tape is listed in Table 1, and the unit is parts per hundreds (phr) unless otherwise specified. In Table 1, the plasticizer is bis(2-ethylhexyl) phthalate, the modifier is methyl methacrylate-butadiene-styrene copolymer, the lubricant is stearic acid soap, and the colorant is ultramarine organic type. The isolation layer material is a copolymer of ethyl acetate, maleic anhydride, and vinyl chloride. The metal salt compound is a mixture of calcium salt compound and zinc salt compound (abbreviated as calcium/zinc salt compound in Table 1) or a mixture of barium salt compound and zinc salt compound (abbreviated as barium/zinc salt compound in Table 1). In Examples 1 to 3, an addition ratio of the calcium salt compound and the zinc salt compound is 1:4, and in Comparative Examples 1 to 3, an addition ratio of the mixture of the barium salt compound and the zinc salt compound is 1:4.

According to the ASTM D3330 standard test method, the peeling strength (P₀) of the UV release tape on the silicon wafer and the peeling strength (P₁) of the UV release tape on the silicon wafer after ultraviolet light irradiation are measured, and a change rate of the peeling strength ((P₀−P₁)/P₀) is calculated. In addition, the ultraviolet-visible-near-infrared spectrophotometer model “SHIMADZU UV-3600i Plus” is used to measure the ultraviolet light transmittance of the UV release tape. The peeling strength and the UV transmittance of the UV release tape are listed in Table 1.

TABLE 1

| Substrate layer material | | | | Parts per hundreds | |
|---|---|---|---|---|---|
| Lubricant | Modifier | Plasticizer | PVC powder | (phr) | |
| 0.1 | 2.0 | 40 | 100.0 | 1 | Example |
| 0.1 | 2.0 | 40 | 100.0 | 2 | |
| 0.1 | 2.0 | 40 | 100.0 | 3 | |
| 0.1 | 2.0 | 40 | 100.0 | 1 | Comparative |
| 0.1 | 2.0 | 40 | 100.0 | 2 | Example |
| 0.1 | 2.0 | 40 | 100.0 | 3 | |

| Peeling | | | | | | | Change |
|---|---|---|---|---|---|---|---|
| strength | | UV | Isolation | Barium/ | Calcium/ | | rate of |
| [symbol] | | transmit- | layer | zinc | zinc | Col- | peeling |
| [symbol] | [symbol] | tance | material | [symbol] | [symbol] | orant | [symbol] |
| 0.05 | 19 | 80% | None | 0 | 2.0 | 2.5 | 0.9974 |
| 0.09 | 19 | 78% | None | 0 | 4.0 | 2.5 | 0.9953 |
| 0.1 | 19 | 78% | Yes | 0 | 4.0 | 2.5 | 0.9947 |
| 5.8 | 16 | 62% | None | 2.0 | 0 | 2.5 | 0.6375 |
| 7.0 | 16 | 51% | None | 4.0 | 0 | 2.5 | 0.5625 |
| 0.26 | 14 | 50% | Yes | 4.0 | 0 | 2.5 | 0.9814 |

[symbol]

indicates data missing or illegible when filed

According to the results in Table 1, the UV release tape of the present disclosure has an optimal ultraviolet light transmittance, so the degumming effect of the UV release layer 2 can be ensured, and adhesive residue after the UV release tape is peeled off from a silicon wafer can be avoided. Specifically, the ultraviolet light transmittance of the UV release tape is greater than 70%, and preferably, the ultraviolet light transmittance of the UV release tape is greater than 75%.

According to the results in Table 1, the UV release tape of the present disclosure has a proper peeling strength, can be adhered onto silicon wafers or other electronic components, and can be easily peeled off after being exposed to ultraviolet light and is convenient to use. Specifically, the peeling strength of the UV release layer is greater than 10 N/in before being exposed to the ultraviolet light, and the peeling strength of the UV release layer is less than 0.3 N/in after being exposed to the ultraviolet light. Preferably, the peeling strength of the UV release layer is greater than 18 N/in before being exposed to the ultraviolet light, and the peeling strength of the UV release layer is less than 0.5 N/in after being exposed to the ultraviolet light.

### Beneficial Effects of the Embodiment

One of the beneficial effects of the present disclosure is that, by virtue of “a material of the substrate layer including polyvinyl chloride, a plasticizer, and a metal salt compound”, and “the metal salt compound including a calcium salt compound and a zinc salt compound” the UV release tape can maintain a proper peeling strength and an optimal peeling strength after a long-term use, and does not leave an adhesive residue.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A UV release tape, comprising:
a substrate layer, wherein the a material of the substrate layer includes a polyvinyl chloride, a plasticizer, and a metal salt compound,
wherein the metal salt compound includes a calcium salt compound and a zinc salt compound, and an amount of the metal salt compound ranges from 1 phr to 8 phr based on the polyvinyl chloride having a total weight of 100 phr;
a UV release layer; and
a separation layer, wherein the UV release tape is disposed between the substrate layer and the separation layer;
wherein a peeling strength of the UV release layer toward a silicon wafer is greater than 10 N/in, and after being exposed to ultraviolet light, the peeling strength of the UV release layer toward the silicon wafer is less than 0.3 N/in.

2. The UV release tape according to claim 1, wherein an addition ratio of the calcium salt compound and the zinc salt compound ranges between 1:1 and 1:10.

3. The UV release tape according to claim 1, wherein the plasticizer is added in an amount of 20 phr to 65 phr based on the polyvinyl chloride having a total weight of 100 phr.

4. The UV release tape according to claim 1, wherein one surface of the substrate layer has an isolation layer, and the isolation layer is in contact with the UV release layer.

5. The UV release tape according to claim 4, wherein a material of the isolation layer includes an ethyl acetate-maleic anhydride-vinyl chloride copolymer, a copolymer of methyl methacrylate and a natural rubber, or a mixture of a polyvinyl chloride and a vinyl chloride resin.

6. The UV release tape according to claim 5, wherein a material of the isolation layer includes 75 phr to 95 phr of a polyvinyl chloride and 5 phr to 25 phr of a vinyl acetate resin.

7. The UV release tape according to claim 5, wherein the vinyl chloride resin includes a vinyl chloride-vinyl acetate binary copolymer, a vinyl chloride-vinyl acetate-vinyl alcohol terpolymer, a vinyl chloride-vinyl acetate-maleic anhydride terpolymer, a vinyl chloride-vinyl acetate-hydroxyethyl acrylate terpolymer, or a combination thereof.

8. The UV release tape according to claim 1, wherein the UV release layer is formed by an adhesive composition, and the adhesive composition includes: 20 phr to 60 phr of an acryl polymer, 2 phr to 20 phr of an acrylic polymer, 0.2 phr to 2 phr of a hardener, and 0.5 phr to 5 phr of a photoinitiator.

9. The UV release tape according to claim 1, wherein an ultraviolet light transmittance of the UV release tape is greater than 70%.

10. The UV release tape according to claim 1, wherein a thickness of the substrate layer ranges from 60 microns to 90 microns.
